(19) United States
(12) Patent Application Publication
(10) Pub. No.: US 2010/0241901 A1
(43) Pub. Date: Sep. 23, 2010

(54) Method and apparatus for checking a control program in an industrial system

(76) Inventor: Roland Jahn, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/703,320

(22) Filed: Feb. 10, 2010

(30) Foreign Application Priority Data
Feb. 12, 2009 (EP) 09152650.9

(51) Int. Cl. G06F 11/07

(52) U.S. Cl. 714/26; 714/E11.029

(57) ABSTRACT

Industrial systems (2) have complex process control systems with many degrees of freedom for parameterization. To find faults during the parameterization, the invention proposes a method for checking a control program (12) in order to control an industrial system (2), in which data of the control program (12) is read into a database (20) and a test routine (24) checks the control program (12), on the basis of data, for compliance with defined rules and displays rule infringements.

The invention relates to a method for checking a control program for controlling an industrial system.

Industrial systems, such as power plants or industrial production systems, have complex process control systems, which control the individual system elements of the industrial system and the interaction thereof during operation of the industrial system. Such a process control system provides an operator or user of the industrial system with a large degree of freedom in terms of configuring and parameterizing the process control system in order to fulfill the project-specific task.

In parallel with these degrees of freedom, the possibility of generating unwanted control sequences as a result of incorrect programming of individual system elements or the interaction thereof increases, thereby challenging the guarantee of a fault-free operation of the industrial system. To find programming faults in a process control system, numerous possible statuses of the industrial system are run through within the scope of system tests or during the commissioning of an industrial system and faults are detected by manual searches and are subsequently eliminated.

It is an object of the invention to specify a method for checking a control program for controlling an industrial system, with which programming faults in the control program can be reliably found.

This object is achieved by a method of the type cited in the introduction, in which in accordance with the invention data relating to the control program is read into a database and, on the basis of the data, a test routine checks the control program for compliance with defined rules and outputs rule infringements. Programming faults can be uncovered, which cannot be easily found by means of system tests, e.g. if they only occur in a very special parameter interaction. The control of the industrial system can be improved and the operation can be implemented more reliably.

An industrial system can be any system in which an industrial process is controlled electronically. The control program may be a process control system for controlling some or all processes of a part of or the entire industrial system. It may include a plurality of subprograms, which can interact with one another. Reading the data of the control program into the database can take place with the aid of a read-in routine of the testing apparatus. The database may be part of a database management system for managing data in one or several databases. The test routine may be a computer program or part of a computer program, in which the defined rules can be stored.

The output of rule infringements can take place in the form of one or several lists, which are expediently visualized, in other words can be output or displayed on a monitor. The check can take place in that the test routine checks the selected control sequences of the control program, with the aid of a checklist, for compliance with the defined rules. Selection of the control sequences can take place by means of an operator, who selects individual control sequences or a category of control sequences for checking purposes. Control sequences may be circuitry between system elements and/or an interaction of system elements. A system element can be a component of the industrial system, such as a sensor, a valve or a motor, or a system element in the form of a software unit, e.g. a module driver, which can be related to a component, in other words hardware, and can also be stored in the component. The checklist can contain individual parameters of the test, for instance level values, sequencers, special circuitry and such-like. The checklists are expediently created according to defined test criteria which can be selected by an operator of the testing apparatus.

To be able to check a series of different control programs of different industrial systems, it is advantageous to implement the method for checking by means of a testing apparatus which is independent of the industrial system. Here the data is advantageously read into the testing apparatus by a control server in the industrial system for instance, said testing apparatus containing the test routine. The testing apparatus can now test the control program or parts thereof with the aid of the test routine and output rule infringements, without being dependent on an operation of the industrial system or influencing an operation of the control server, e.g. the performance thereof.

In an advantageous embodiment of the invention, the test routine tests the control program for correct parameterization and circuitry of system elements in the industrial system. A parameter can be a changeable element of a subprogram, which is set to a concrete value in the case of the subprogram being called up herefor in each instance. A parameter may also be an argument, which is transferred to a subprogram of the control program. A switch, which controls the procedures in the subprogram, is likewise possible.

The rules are advantageously plausibility rules and the rule infringements are implausibilities. Program-specific tests are herewith not detected, and the test routine can be used universally.

The test routine further advantageously tests whether values assigned to system elements are plausible in respect of system element data. Level values for a system element which lie outside an output value range of the system element and can thus never be exceeded or undershot can therefore be detected. A level value is used to trigger a control process, this control process can therefore never be triggered. A test can also be carried out to determine whether an output value range of a system element exceeds or falls short of a correspondingly wired input value range of another system element, so that processes can if necessary not be detected.

The test routine expediently checks several system elements of the industrial system which emit the same signal to determine whether they are adequately separated from one another in terms of a defined property. A circuitry of several system elements, also past system boundaries and/or boundaries of functional areas, can be checked in this way by several system elements. The property can be a property of the industrial system, e.g. the independency of an energy supply of the same system elements or their connection to alarms which are independent of one another. If two or more system elements, which are redundant for safety reasons, are arranged on a printed circuit board, an interruption in the power supply to this printed circuit board results in all system elements failing and thus in reduced reliability against interferences. If on the other hand three evaluation elements are supplied with an input signal by only one sensor, the failure of this one sensor results in all three evaluation elements failing. System elements emitting the same signal are expediently elements, which emit their signal to a shared signal receiver. Furthermore, it is possible to check whether activatable level values are actually activated, in particular all activatable level values of the control program or a part of the control program, for instance a functional area. If the activation of a level value was forgotten upon creation of the control program, this can be detected.

It may however ensue that some unnecessary level values cannot be deactivated in a hardware or software-related fashion or that level values, which are not necessary for the operation of the industrial system, do not develop as a result of the programming history. In order not to check too many unnecessary level values, it is advantageous for the test routine to check system elements to determine whether level values are activated at signal outputs of system elements in the industrial system, which are connected to a signal input of another system element in the industrial system.

The number of level values to be checked can also be reduced, if the test routine checks level values at signal outputs of system elements, which were set to another value from a preset value, to determine whether the level values are activated. The adjustment of a level value from a preset value and/or default value also indicates that this level value is determined for a use. Checking the activation of this level value is thus particularly meaningful.

It is also proposed that the test routine compares documented specifications relating to output signals of system elements with level values, which are assigned to these output signals. A volatile faulty programming, which is described relative to a system element, may infer that said system element is to be activated, switched or is to implement a process in the case of a certain value of a physical parameter. A corresponding level value for activating this process is however set to a different value. Such a fault can be easily found by comparing the stored specifications with the level values.

An operating fault during operation of the industrial system is usually signaled to an operator and/or control center of the industrial system. The operator thereupon checks the severity of the fault by attempting to find out, on the basis of graphic displays, the system element or process which is interrupted. If a corresponding graphic display is missing for an alarm message, the operator is in some instances not able to localize the fault and ignores said fault. In order to prevent this, it is advantageous for alarm messages relating to operating faults in the industrial system, for instance a system element or a process, which are provided by the control program for output to an operator, to be checked to determine whether a graphic display for visualizing a localization of the fault and/or the relevant system element and/or a process is stored in the control program in respect of alarm messages, in particular any possible alarm message.

An operating fault is frequently sought in accordance with the cause of this fault. To this end, signals and physical parameters of the industrial system in an archive are sought through for a possible fault cause. If signals of system elements of the industrial system, which could lead to operating faults, in particular those assigned level values, are not archived, it may be that a corresponding fault cannot be found. To avoid this, it is advantageous if the test routine checks the control program to determine whether an archiving routine of the control program is prepared to archive values of such output signals of system elements in the industrial system, which are assigned level values. The archiving can take place permanently, regularly or in another predetermined manner.

It is also proposed to eliminate rule infringements in a control-based manner with the aid of a repair routine and the data is changed accordingly. In this way, simple programming faults can be eliminated in a standardized fashion and a revision of the control program can be simplified. The data is expediently read into the control server from a control server of the industrial system, corrected in a control-based fashion and input back into the control server in a corrected form.

An external check of the control program enables several different control programs of different industrial systems to be checked according to the same rules. A control program for controlling a first industrial system and then a control program for controlling a second industrial system which differs from the first industrial system is advantageously initially checked with the aid of the test routine, for compliance with the same defined rules. The different industrial systems focus here on different working objectives.

The invention also focuses on a testing apparatus for checking a control program for controlling an industrial system. It is proposed in accordance with the invention for the testing apparatus to include a database and a check routine, which, in conjunction with a processor-controlled computing means is provided in order to check the control program, with the aid of the data, for compliance with defined rules and to output rule infringements. In particular, the testing apparatus includes a reading-in routine for reading in the data of the control program. It can look for faults in a standardized fashion and standardized protocols with alarm messages can be output as quality records and/or correction specifications.

The test routine is expediently used to execute one or several of the afore-cited method steps.

The invention is described in more detail with reference to exemplary embodiments, which are shown in the drawings, in which;

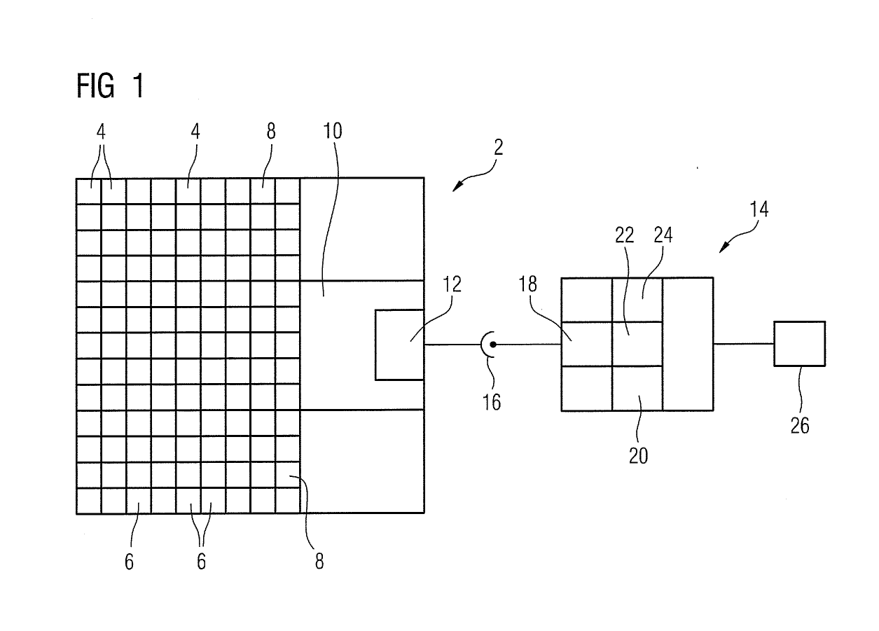

FIG. 1 shows an industrial system and a testing apparatus in a very stylized form,

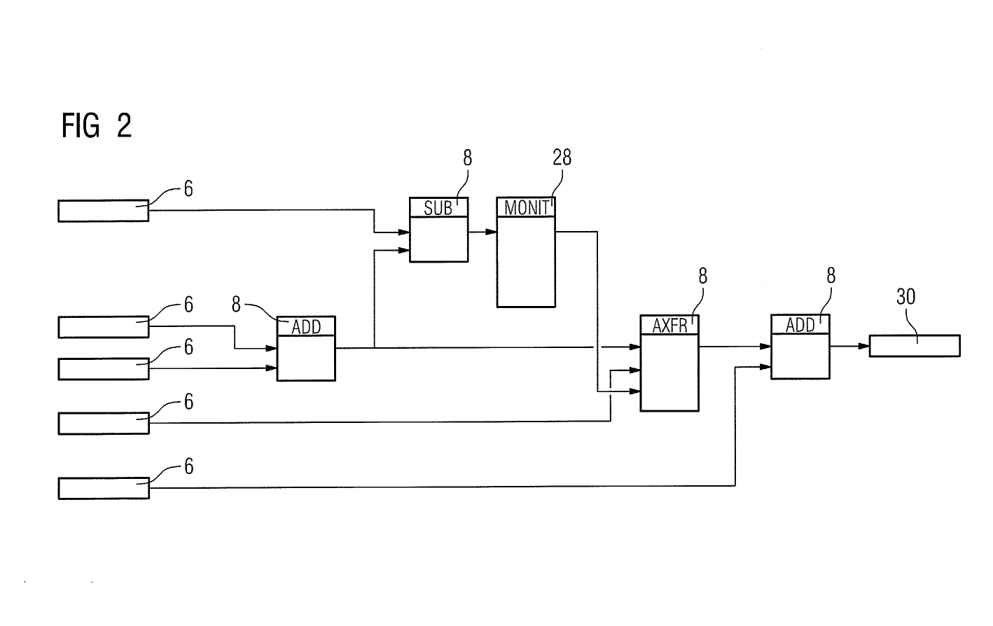

FIG. 2 shows a cutout from a functional plan of an industrial system,

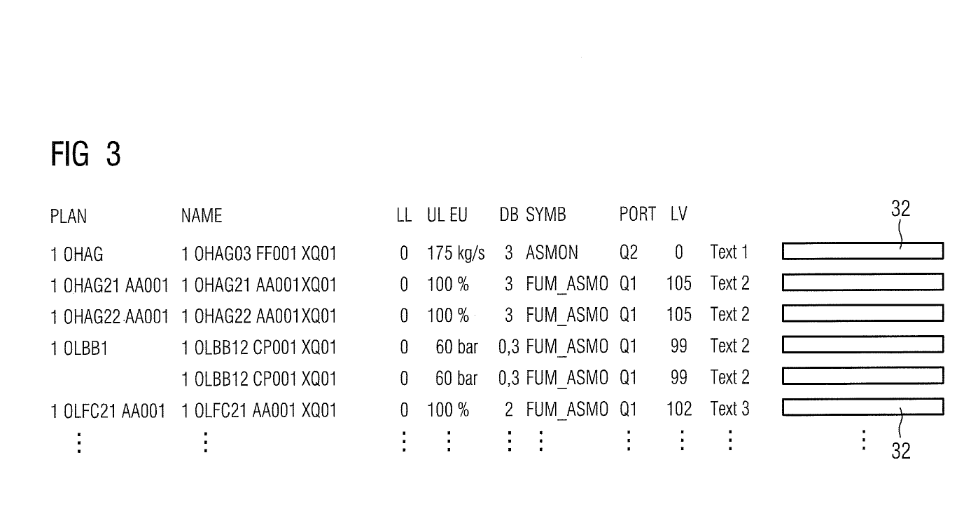

FIG. 3 shows a cutout from a tabular list of implausibilities found in data, which underlie the functional plan,

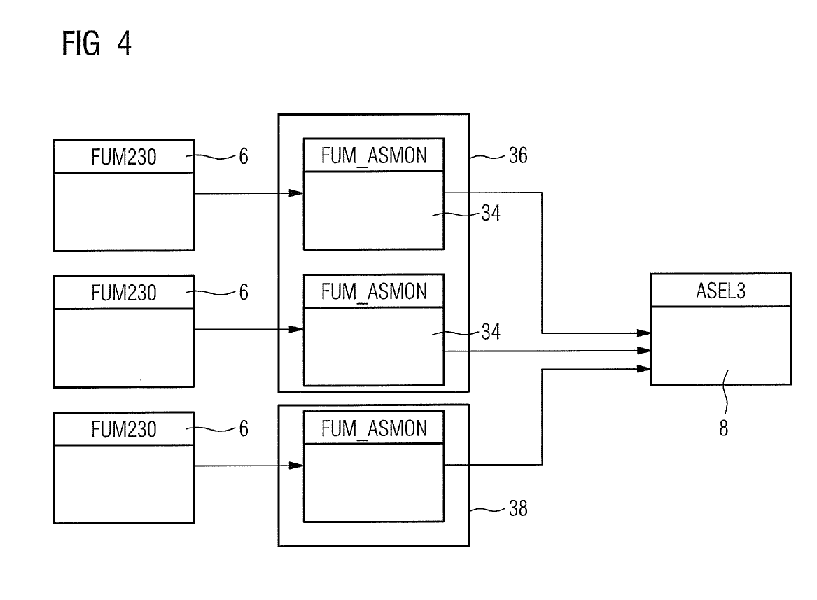

FIG. 4 shows a functional diagram of three temperature sensors and

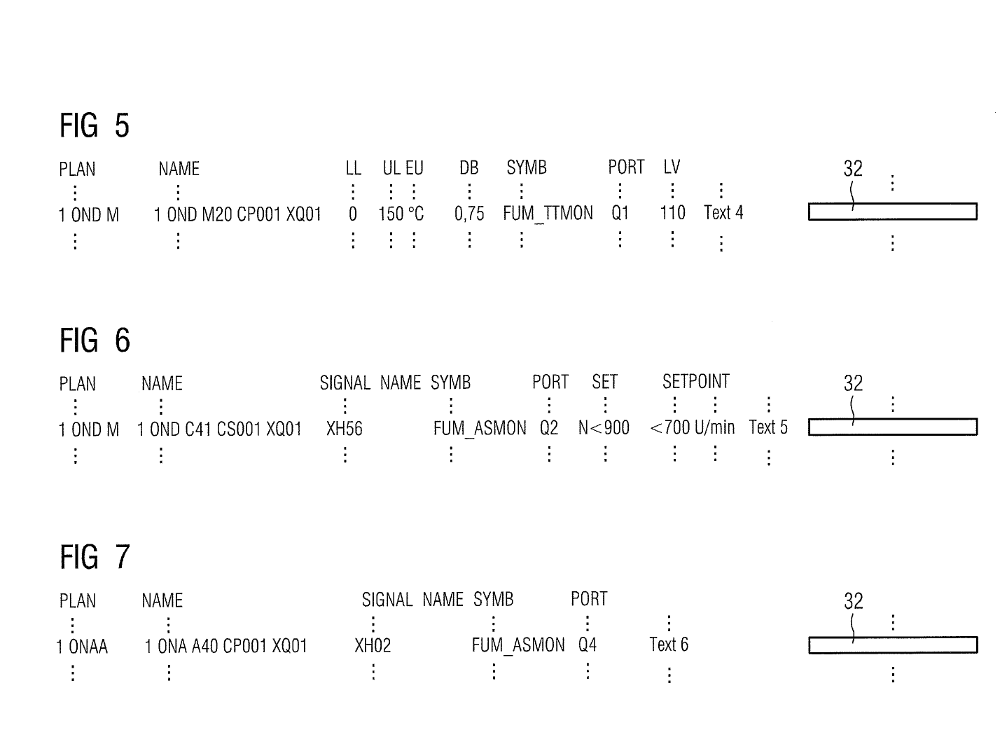

FIG. 5-FIG. 7 show three cutouts of fault lists, which were found by a test routine.

FIG. 1 shows a very schematic representation of an industrial system 2 with a plurality of actuators 4, sensors 6 and further system elements 8. The system elements 4, 6, 8 of the industrial system 2 are controlled by a control program 12, which is stored on a server 10 of the industrial system 2.

A testing apparatus 14 in the form of a portable computer is connected via an interface 16 to the server 10 in order to check the control program 12. Control program 12 data is read into a database 20 of the testing apparatus 14 with the aid of a reading-in routine 18. This data forms a part of the control program, which includes for instance four larger files which interact in order to control the industrial system 2, one file of which is read into the database 20. This file includes a list of all controlled system elements 4, 6, 8 of the industrial system 2, its ports, its connections to other ports and graphic displays and control elements for an operator in the control center of the industrial system 2.

The industrial system is divided into twenty-two functional areas, includes around 110,000 system elements, 1.2 million ports and around 6 million signal connections between the ports or parameterizable information. With the aid of a computing means 22 in the form of a processor and a test routine 24 in the form of a computer program, the testing apparatus 14 checks the data listed in tables in the revised file for compliance with defined rules, which are stored in the test routine 24. Discovered rule infringements are output in tables onto an output means 26, for instance a monitor or a printer, for visualization purposes. A further function of the testing apparatus 14 consists in the automatic correction of data and thus the control program 12 in accordance with preset rules. The corrected data is given back to the server 10 via the interface 16, so that the control program 12 is now modified.

FIG. 2 shows a small cutout of a functional plan of the 21st functional area of the industrial system 2, which is embodied as a remote heating system. Sensors 6 in the industrial system detect condensate flows in a piping system in the industrial system 2 and send signals containing a parameter value as information, at regular intervals, for instance 20 kg/sec. These parameter values are linked to one another in logical system elements 8 in the form of functional modules in accordance with defined rules, with a further system element 28 checking the thus linked parameters for a level value. A further system element 30 embodied as a functional element is used to exchange signals with the other section of the industrial system 2.

When testing the data and/or control program 12 of the industrial system 2, the same are checked for defined rules. Such rules are explained by way of example on the basis of FIG. 3. FIG. 3 shows a list of infringements of defined rules which are output on the outputting means 26, said defined rules being examined for individual data or data areas.

In the case of the data tested by way of example in FIG. 3, all system elements 28 of a functional area or the whole industrial system 2 which check the level values are checked for plausibility of the signals to be achieved with the set level values. In the first column, a system element with the reference 1 OHAGO3 FF001, which can be found in plan 1 OHAG of the first functional area of the industrial system 2, is specified. On the basis of sensors 6 and system element 8, this system element 28 achieves a signal during operation, which is able to achieve a parameter value between 0 (LL=Lower Level) and 175 kg/sec (UL=Upper Limit, EU=unit). The type of level value, which is specified with the aid of a symbol name (SYMB) is provided with a hysteresis (DB) of 3 kg/sec. The level value (LV=Level Value) is set to 0 kg/sec.

The rule checked in this situation means that the set, in other words activated level value, has to be switchable. The test routine here has found the fault such that the considered level value cannot be switched and has described this fault with the aid of a first text:
Text 1: “Fault: level value/hysteresis combination outside the measuring range”

In this situation, the signal value has to drop below the value of −3 kg/sec, in order to switch the level value of 0 kg/sec., including its hysteresis of 3 kg/sec. As a negative condensate flow is not possible, and the sensors 6 are also not able to identify such a negative flow, the level value cannot be switched. An operator of the testing apparatus 14 or a programmer of the control program 12 or another person is able to localize the sought fault with the aid of the functional plans and provide the data and/or the control program 12 with a corrected level value. The fault is herewith eliminated and the industrial system 2 can be controlled more reliably.

In the second column of the list of faults found in FIG. 3, the rule is checked to determine whether the level value lies within a possible value range including a hysteresis or tolerance. All connections and/or parameterization possibilities were examined for this fault and faults were found, some of which are shown by way of example in the second to fifth columns of the list in FIG. 3. In the second column, a signal can achieve a system element 28 monitoring a level value, which can adopt the parameter values between 0 and 100%. A tolerance range of 3% also allows the signal to adopt a parameter value of up to 103%. However, the level value is set to 105% and is thus not switchable. The second text thus specifies:
Text 2: “Fault: Level value outside measuring range and tolerance”

A further fault is listed in the last column of the list in FIG. 3, said fault actually not being a fault but instead only an abnormality which is treated as a fault. In this example the level value is below 102% in a possible value range of 0 to 100% with a tolerance of 2%. The parameter value of the signal can therefore reach the level value of 102% here. The third text reads:
Text 3: “Note: Level value in the tolerance range outside measuring range”

If this is actually a fault, it can be eliminated by an operator. If the level value is however set correctly to 102%, a corresponding comment can be inserted into an input field 32, for instance that the level value is correct and wanted.

A further rule is shown with the aid of FIG. 4, and is used to check the data. This data shows that three structurally identical sensors 6 measure a physical variable, for instance a feed water passage. The three sensors 6 measure all the same variables and for both safety and availability reasons are available redundantly twice. Each sensor 6 is connected to an input module with the reference FUM 230 and also to an input driver 34, which creates a logical signal from the analogue signal of the relevant sensor 6. The three input drivers 34 are connected to a single system element 8, which evaluates the triple measurement and correspondingly conveys the signals to further system elements.

The rule to be checked is a rule for complying with the method-specific redundancies within control technology. It means that each sensor 6 and each input driver 34 is to be arranged on its own module 36, 38, with each module 36, 38 being supplied with the necessary operating voltage by means of its own power supply. By checking the rule, the data determines that both input drivers 34 shown in the upper section of FIG. 4 are arranged on a shared module 36 and therefore only have one single power supply. In the event of an interruption in this power supply, the two input drivers 34 fail together. This contradicts the safety rule of the separate power supplies. A corresponding alarm message is displayed in a list, which can be structured in the same fashion as the list in FIG. 3.

In this way, circuitry is checked in accordance with defined rules. The combination of system elements 6, 8, 34, is also tested across a system boundary, e.g. in accordance with its arrangement within the industrial system 2.

Further rules are explained by way of example on the basis of FIGS. 5 to 7. In the list of faults and/or alarm messages only indicated in FIG. 5 by a single column, a check is carried out to determine whether a level value, which is activated in its value setting by a preset value, for instance 0 or 99, was set to another value. A level value set to 110° C. was found at the system element 1 OND M20 CP001 for instance, which was however not activated.

The fourth text reads accordingly:
Text 4: “Note: the default value was changed, the level value was however not activated”

In a further rule, it is possible to check whether level values, which are connected to a further system element, are activated. If a port Q1, Q2, . . . , Qn outputting a level value is connected to a further port and/or system element of the industrial system 2 and the corresponding level value is not activated, the corresponding module and level value can be shown in a list in a similar fashion to FIG. 5 and can be explained with the text for instance:
“Note: level value is connected but not activated”

In a further rule, the data and/or facts in the control program 12 are checked to determine whether a documented setting of a system element conforms to a set level value. If a process is switched for instance at a speed N from 900 U/min, the correspondingly set level value lies at 700 U/min for instance, so a process is switched at a lower speed, which is only to occur with the higher speed. A corresponding fifth text may read:
Text 5: “Note: setting does not correspond with the combination of the level value and EU”

When checking the rule, which is shown on the basis of the indicated list in FIG. 7, a check was carried out to determine whether all level value-related signals are archived. If a sensor provides a signal for instance which is received by a driver and this signal is connected such that it can exceed or fall short of a level value, which is activated, and trigger a corresponding control process, this signal is checked to determine whether it triggers an archive entry. This archive entry can take place regularly or in accordance with a preset rule. If no archive entry is triggered, a corresponding alarm message is displayed, the sixth text of which may read:
Text 6: “Fault: Level value not in archive”

A further rule, the checking of which is meaningful, is the checking of all alarms, which are displayed to an operator, for certain properties. Such a property may be whether it provides a graphic display in the control program and/or in a file of the control program for this alarm, that can call up an operator, e.g. a master display of the industrial system 2, in order to be able to link the corresponding alarm with a system element of the industrial system 2. If an alarm is assigned to a system element, which cannot be found in any operator display, a corresponding fault and/or rule infringement is displayed, in a similar manner to that described in FIGS. 5 and 7.

A further function of the testing apparatus 14 is the automated correction of faults. The lack of archive entries of driver signals can be automatically eliminated for instance and the control program 12 and/or its data can be changed such that each level value-related signal triggers archive entries in a preset fashion. Such a fault can initially be listed and an operator can call up a corresponding repair routine and first of all eliminate these faults and/or all listed faults by means of a corresponding command.

It is likewise possible for preset faults to be eliminated upon their discovery without an operator request. Smaller, non-critical faults can be automatically eliminated in this way, without an operator having to look over a series of faults and having to come to a decision on said faults.

1. A method for checking a control program (12) for controlling an industrial system (2), in which data of the control program (12) is read into a database (20) and a test routine (24) checks the control program (12), on the basis of data, for compliance with defined rules and displays rule infringements.

2. The method as claimed in claim 1,
characterized in that
the data from a control server (10) of the industrial system (2) is read into a testing apparatus (14), which is independent of the industrial system (2) and has the test routine (24).

3. The method as claimed in claim 1 or 2, characterized in that the test routine (24) checks the control program (12) for correct parameterization and/or circuitry of system elements (4, 6, 8) of the industrial system (2).

4. The method as claimed in one of the preceding claims, characterized in that the rules are plausibility rules and rule infringements are implausibilities.

5. The method as claimed in one of the preceding claims, characterized in that the test routine (24) checks whether values assigned to system elements (4, 6, 8) of the industrial system (2) are plausible in respect of system element data.

6. The method as claimed in one of the preceding claims, characterized in that the test routine (24) compares value ranges of output signals of system elements (4, 6, 8) of the industrial system (2) with level values, which are assigned to these output signals.

7. The method as claimed in one of the preceding claims, characterized in that
the test routine (24) checks several system elements (4, 6, 8) of the industrial system (2) emitting the same signal to determine whether they are adequately separated from one another in respect of a defined property.

8. The method as claimed in one of the preceding claims, characterized in that
the test routine (24) checks level values at signal outputs of system elements (4, 6, 8) of the industrial system (2), which are connected to a signal input of another system element (4, 6, 8) of the industrial system (2), to determine whether the level values are activated.

9. The method as claimed in one of the preceding claims, characterized in that the test routine (24) checks level values at signal outputs of system elements (4, 6, 8) of the industrial system (2), which were set to another value from a preset value, to determine whether the level values are activated.

10. The method as claimed in one of the preceding claims, characterized in that the test routine (24) compares documented specifications relating to output signals of system elements (4, 6, 8) of the industrial system with level values, which are assigned to these output signals.

11. The method as claimed in one of the preceding claims, characterized in that the test routine (24) checks alarm messages relating to operating faults in the industrial system (2) which are provided by the control program (12) for displaying to a user, to determine whether a graphic display for visualizing a localization of the fault is stored in the control program (12) for the alarm message.

12. The method as claimed in one of the preceding claims, characterized in that
the control program (12) is tested by the test routine (24) to determine whether an archiving routine of the control program (12) is prepared to archive values of such output signals of system elements (4, 6, 8) of the industrial system (2) which are assigned level values.

13. The method as claimed in one of the preceding claims, characterized in that rule infringements are eliminated on a control basis with the aid of the test routine (24) and the data is changed accordingly.

14. The method as claimed in one of the preceding claims, characterized in that
a control program (12) for controlling a first industrial system (2) and then a control program (12) for controlling a second industrial system which differs from the first industrial system (2) are initially checked, with the aid of the test routine (24), for compliance with the same defined rules.

15. A testing apparatus (14) for checking a control program (12) for controlling an industrial system (2), comprising a database (20), a reading-in routine (18) for reading data from the control program (12) into the database (20) and a test routine (24), which is provided in conjunction with a processor-controlled computing means (22) for checking the control program (12), on the basis of data, for compliance with defined rules and for displaying rule infringements.
